(19) United States
(12) Patent Application Publication
(10) Pub. No.: US 2015/0028136 A1
(43) Pub. Date: Jan. 29, 2015

(54) VALVE FOR METERING FLUID

(71) Applicants: Michael Fischer, Niefern-Oeschelbronn (DE); Andrej Elsinger, Ditzingen (DE); Michael Mayer, Wannweil (DE); Pablo Antonio Napal Jimenez, Stuttgart (DE)

(72) Inventors: Michael Fischer, Niefern-Oeschelbronn (DE); Andrej Elsinger, Ditzingen (DE); Michael Mayer, Wannweil (DE); Pablo Antonio Napal Jimenez, Stuttgart (DE)

(73) Assignee: ROBERT BOSCH GMBH, Stuttgart, DE (DE)

(21) Appl. No.: 14/383,064

(22) PCT Filed: Jan. 30, 2013
(86) PCT No.: PCT/EP2013/051803

§ 371 Date: Sep. 4, 2014

(30) Foreign Application Priority Data
Mar. 7, 2012 (DE) 10 2012 203 607.5

(51) Int. Cl. F02M 63/00

(52) U.S. Cl. CPC F02M 63/0033
USPC 239/584

(57) ABSTRACT

A valve for metering a fluid, e.g., for the injection of fuel in a fuel-injection system of internal combustion engines, includes: an intake for the fluid; a metering orifice for the fluid; and an elongated, hollow-cylindrical flow channel leading from the intake to the metering orifice, the flow channel having an outer channel wall and an inner channel wall. In order to influence the hydraulic resonances resulting from the structural design in such a way that an excitation of critical structural modes caused by the installation is prevented, the flow channel is subdivided into at least two channel sections which are separated from one another, and a flow connection for the fluid is established between consecutive channel sections.

### BACKGROUND OF THE INVENTION

1. Field of the Invention

The present invention relates to a valve for metering a fluid, in particular for the injection of fuel in a fuel-injection system of internal combustion engines.

2. Description of the Related Art

A known valve for metering a fluid (described in published German patent application document DE 10 2009 026 532 A1) has an intake, accommodated in a connecting piece, for the fluid, a metering orifice formed in a valve body, for metering a dosed fluid quantity with the aid of a valve needle which closes and opens the metering orifice and is controlled by a piezoelectric actuator and a valve-closure spring, and an elongated, hollow-cylindrical flow channel which leads from the intake to the metering orifice. The connecting piece and the valve body are fixed in place inside a valve housing and seal it at a housing end in fluid-tight manner in each case. An elongated sleeve extends between the connecting piece and the valve body, coaxially with respect to the valve housing; the sleeve is mounted on the connecting piece and valve body via its two sleeve ends and accommodates a valve subassembly, which is made up of the piezoelectric actuator and a hydraulic coupler. The annular gap remaining between sleeve and valve housing constitutes the hollow-cylindrical flow channel for the fluid, so that the inner channel wall of the flow channel is formed by the sleeve, and the outer channel wall of the flow channel is formed by the valve housing. Installed immediately upstream of the metering orifice in the valve body is a valve chamber, which is connected to the flow channel via a radial intake bore introduced in the valve body, while a connection from the flow channel to the intake is provided in the connecting piece.

It has become obvious that pressure surges arise when metering the fluid, which is normally under high pressure, i.e., when opening and closing the valve; these pressure surges generate hydraulic vibrations which in turn excite the add-on structure at the valve to vibrations and lead to noticeable and undesired noise development. The shape of the fluid volume, predefined by the elongated hollow-cylindrical flow channel, generates pronounced hydraulic resonances across the entire length of the valve, which link quite readily to installation-related structural longitudinal resonances of the valve of typically 3 kHz.

### BRIEF SUMMARY OF THE INVENTION

The valve according to the present invention has the advantage that because of the subdivision of the flow channel into a plurality of channel sections which are separated from each other, and because of the production of a flow connection between the channel sections that follow one another in the flow direction, the hydraulic resonances resulting from the structural shape are able to be influenced to such an extent that an excitation of critical installation-related structural modes no longer occurs, i.e., hydraulic resonances within the critical frequency range of typically 3 kHz are no longer able to arise. In the least complicated case, the flow channel is subdivided into two channel sections, which means that the fluid volume is subdivided into two partial volumes, halfway in the flow duct. Depending on the required frequency shift, other division ratios or also a plurality of subdivisions of the flow channel at different division ratios are possible.

According to one advantageous specific embodiment of the present invention, the subdivision of the flow channel and the creation of the flow connection between the channel sections is realized in that a ring with a ring gap and a ring thickness or radial annular wall dimension that corresponds to the radial channel width is inserted at at least one channel location in the flow channel. Such a ring advantageously has a rectangular or circular cross-section and is made from a band or wire having a rectangular or circular cross-section. The ring is fixed in place in the flow channel, preferably by a form-locking insertion of the ring in at least one annular groove introduced in the inner and/or outer channel wall of the flow channel.

According to one advantageous specific embodiment of the present invention, two rings are disposed at a short distance one after the other at at least one location inside the flow channel. The rings are advantageously aligned in such a way that their annular gaps are rotated relative to each other in the circumferential direction, preferably by 180°. This structural placement of the rings has the advantage of producing an intermediate volume of the fluid between two consecutive channel sections.

According to one alternative specific embodiment of the present invention, the subdivision of the flow channel and the flow connection between the produced channel sections are realized in that the cross-section is constricted at at least one location in the flow channel. This cross-section constriction is advantageously achieved in that a nose, which extends around the channel wall periphery, projects into the flow channel from at least one of the two channel walls of the flow channel, the nose advantageously being realized by a recess worked into the channel wall. Such a peripheral constriction of the flow cross-section of the flow channel has the advantage that the cross-section of the constriction varies as a function of the fluid pressure, that is to say, that it increases with increasing pressure. When the pressure is reduced, a more effective subdivision of the fluid volume than at high pressure therefore exists, so that at high pressure (higher engine load), a possibly existing adverse effect on the valve operation is advantageously reduced as a result of the fluid volume subdivision. The operating points having high pressure are generally non-critical with regard to noise generation and thus do not require any noise countermeasures anyway.

### BRIEF DESCRIPTION OF THE DRAWINGS

FIG. 1 shows a longitudinal section of a valve for metering a fluid.

FIG. 2 shows an enlarged illustration of cutaway A in FIG. 1.

FIG. 3 shows an enlarged illustration of cutaway A according to a second exemplary embodiment, including a ring which has a rectangular ring cross-section and is inserted in the flow channel.

FIG. 4 shows a perspective view of the ring in FIG. 3.

FIG. 5 shows an enlarged illustration of cutaway A in FIG. 1 according to a third exemplary embodiment, including a ring which has a circular ring cross-section and is inserted in the flow channel.

FIG. 6 shows a perspective view of the ring in FIG. 5.

FIG. 7 shows an enlarged illustration of cutaway A in FIG. 1 according to a fourth exemplary embodiment, including two rings which have a circular ring cross-section and are inserted in the flow channel a short distance from each other.

FIG. 8 shows a perspective view of the two rings according to FIG. 7.

### DETAILED DESCRIPTION OF THE INVENTION

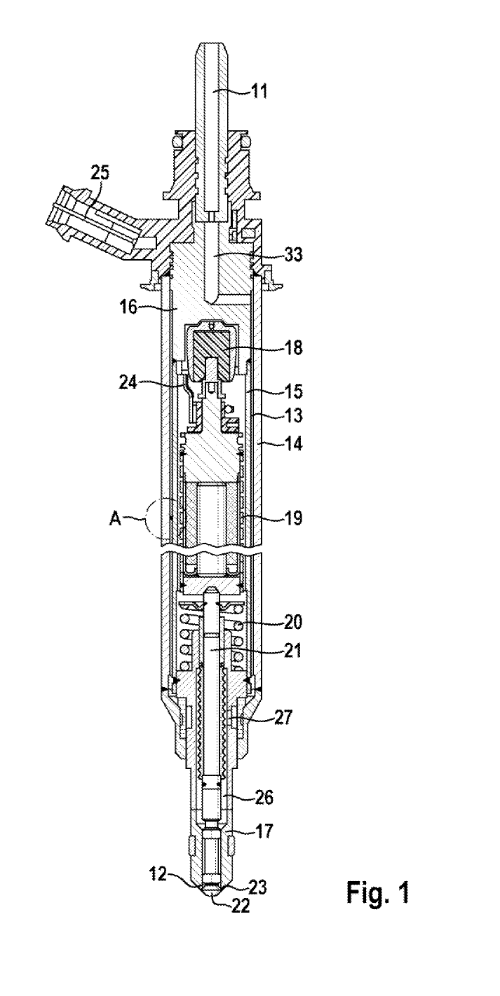

The valve for metering a fluid, shown in longitudinal section in FIG. 1, preferably is used as an injection valve for the injection of fuel in a fuel-injection system of internal combustion engines, the fuel preferably being injected into the combustion cylinder of the internal combustion engine. The valve has an intake 11 for the fluid, a metering orifice 12 for the fluid, and an elongated, hollow-cylindrical flow channel 13 leading from intake 11 to metering orifice 12. Flow channel 13 has an outer channel wall 13a, which is formed by a tubular valve housing 14, and an inner channel wall 13b, which is formed by a sleeve 15 concentrically situated inside valve housing 14.

Valve housing 14 is sealed in fluid-tight manner by a connecting piece 16 at its one end face, and by a valve body at its other end face. Connecting piece 16 includes intake 11, whereas metering orifice 12 is developed in valve body 17. Sleeve 15 is fixed in place in fluid-tight manner at connecting piece 16 via its one sleeve end, and on valve body 17 via its other sleeve end. Integrated into sleeve 15 is a valve assembly, which is made up of a hydraulic coupler 18 gimbal-mounted on connecting piece 16, a piezoelectric or magnetostrictive actuator 19 connected to coupler 18, and a valve closure spring 20 braced on valve body 17. Actuator 19 and valve closure spring 20 engage with opposite effective directions at a valve needle 21, which is guided inside valve body 17 in axially displaceable manner and controls metering orifice 12 together with a closing head 22, which cooperates with a valve seat 23 surrounding metering orifice 12.

Via a contact bridge 24, actuator 19 is connected to an electrical plug connector 25; when a current is supplied, it lifts off closing head 22 of valve needle 21 in the outward direction, counter to the restoring force of valve closure spring 20. When the current is switched off, valve closure spring 20, which is tensioned via valve needle 21 when metering orifice 12 is open, presses closing head against valve seat 23 again, so that metering orifice 12 is closed. The connection between flow channel 13 and metering orifice 12 within valve body 17 is realized by a valve chamber 26 immediately upstream of metering orifice 12, and by a radial bore 27 which leads from flow channel 13 to valve chamber 26, whereas flow channel 13 is connected to intake 11 by a connecting bore 33 introduced in connecting piece 16.

In order to influence the afore-described hydraulic resonances resulting from the structural design in such a way that an excitation of critical structural modes caused by the installation is no longer able to take place, flow channel 13 having an annular flow cross-section is subdivided into at least two channel sections 131, 132 which are separated from each other, and a flow connection for the fluid is created between channel sections 131, 132. In the simplest case, flow channel 13 is subdivided using a 1:1 ratio. However, depending on a desired frequency shift, other ratios and the subdivision of flow channel 13 into more than two channel sections may be required.

The subdivision of flow channel 13 into two or more channel sections and the creation of the flow connections between the channel sections at one or multiple channel locations may be realized in different ways.

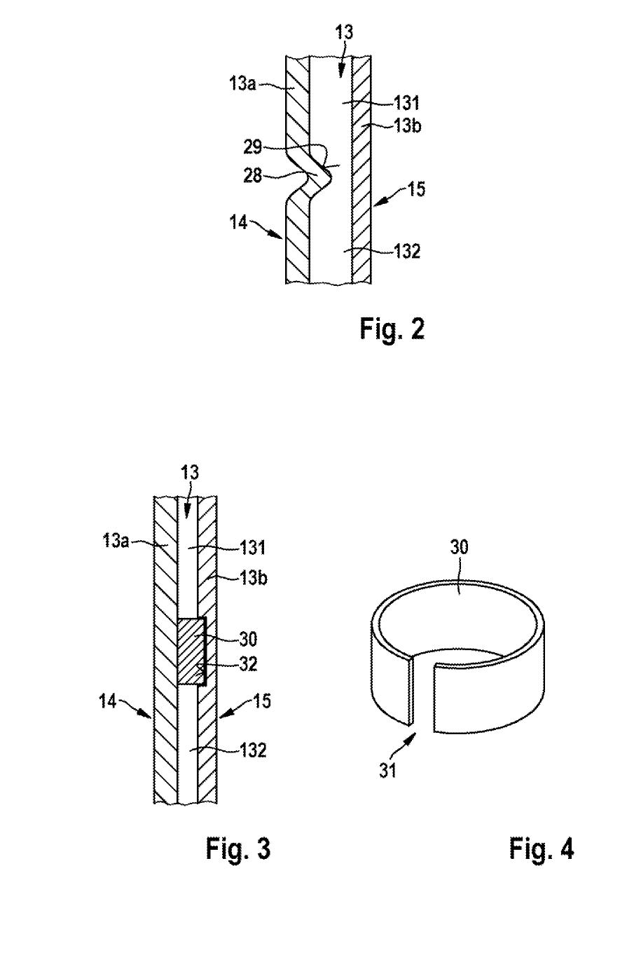

In section A of flow channel 13, shown in enlarged form in FIG. 2, a constriction in the cross-section of the annular cross-section of flow channel 13 has been implemented at one channel location inside flow channel 13. Toward this end, an annular recess 28 is impressed into the outer channel wall 13a formed by valve housing 14, the recess resulting in a nose 29 that extends peripherally along channel wall 13a and projects into flow channel 13. As an alternative, same nose 29 may also be provided on inner channel wall 13b formed by sleeve 15. It is possible to place a separate nose 29 on inner channel wall 13b and on outer channel wall 13a, noses 29 lying opposite each other or at an offset at a short distance. The width of nose 29 viewed in the axial direction may be adjusted to achieve the desired degree of throttling. Typical widths are 1 to 10 mm. The remaining width, viewed in the radial direction, of flow channel 13 at the channel location (gap width) may likewise be selected broader or narrower depending on the desired degree of throttling. Typical gap widths are 0.01 to 0.1 mm.

FIGS. 3 through 8 show three further exemplary embodiments which illustrate how a subdivision into two consecutive channel sections 131 and 132 having a flow connection between channel sections 131 and 132 is obtained at a particular channel location of flow channel 13. In all three cases, rings 30 are used that have a ring size, i.e., ring thickness, or radial ring wall dimension that corresponds to the radial channel width of flow channel 13, and which are inserted in flow channel 13.

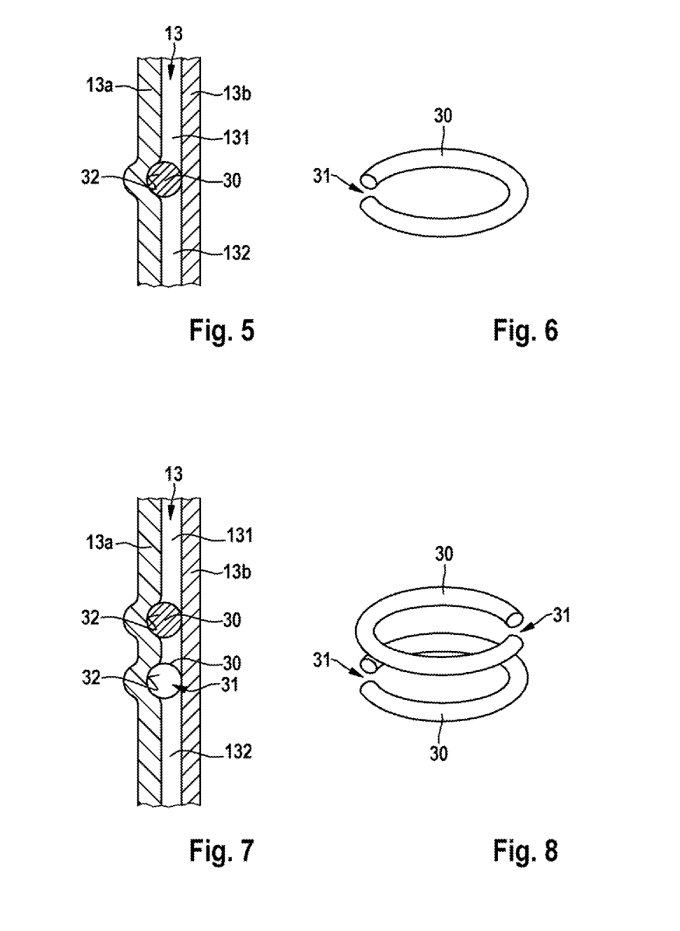

In the two exemplary embodiments of FIGS. 3 to 6, a ring 30 is inserted at the channel location of flow channel 13. Ring 30 is fixed in place on at least one channel wall in flow channel 13, in that ring 30 partially and form-fittingly reaches into an annular groove 32 introduced in at least one of channel walls 13a, 13b. In the exemplary embodiment of FIGS. 3 and 4, ring 30 has a rectangular cross-section, and annular groove 32 is introduced in inner channel wall 13b. Ring 30 preferably is produced from a band. In the exemplary embodiment of FIGS. 5 and 6, ring 30 has a circular cross-section, and annular groove 32 is formed by an annular crease which is impressed in outer channel wall 13a from the direction of the inside of outer channel wall 13a. Ring 30 preferably is produced from a wire.

In the exemplary embodiment of FIGS. 7 and 8, two rings 30 have been inserted in flow channel 13, the rings being placed at a short distance one behind the other and aligned in parallel. Similar to FIGS. 5 and 6, each ring 30 has a circular cross-section and partially projects into an annular groove 32 which is formed by an annular crease impressed in outer channel wall 13a from the direction of its inner side. As illustrated in FIG. 8, rings 30 are aligned in such a way that their annular gaps 31 are rotated relative to each other. A 180° rotation of the annular gaps is preferred. The placement of two rings 30 set slightly apart from each other has the advantage that an intermediate volume of the fluid is produced between two consecutive channel sections. The same effect is obtained by the aforementioned placement of two noses 29 at the outer and inner channel wall 13a, 13b, which are placed a short distance from each other in offset manner.

1-14. (canceled)

15. A valve for injecting fuel in a fuel-injection system of an internal combustion engine, comprising:
an intake for the fluid;
a metering orifice for the fluid; and
an elongated, hollow-cylindrical flow channel extending from the intake to the metering orifice and having an outer and an inner channel wall, wherein the flow channel is subdivided into at least two channel sections separated from each other, and a throttled flow connection for the fluid is provided between consecutive channel sections in the flow direction.

16. The valve as recited in claim 15, wherein, for the subdivision and flow connection, at least one ring having an annular gap and a ring thickness which corresponds to the radial channel width of the flow channel is inserted in the flow channel at at least one channel location.

17. The valve as recited in claim 16, wherein the ring has one of a rectangular or circular cross-section.

18. The valve as recited in claim 17, wherein the ring is formed from one of a band or a wire having one of a rectangular or circular cross-section.

19. The valve as recited in claim 16, wherein the ring is fixed in place on at least one channel wall in the flow channel.

20. The valve as recited in claim 19, wherein the ring partially projects in form-locking manner into at least one annular groove introduced in the at least one channel wall.

21. The valve as recited in claim 16, wherein two rings are situated at a distance one behind the other at the at least one channel location in the flow channel.

22. The valve as recited in claim 21, wherein the two rings are aligned parallel to each other such that annular gaps of the two rings are rotated relative to each other in the circumferential direction.

23. The valve as recited in claim 22, wherein the rotation of the annular gaps of the two rings amounts to 180°.

24. The valve as recited in claim 15, wherein, for the subdivision and flow connection, a constriction of a flow cross-section of the flow channel is implemented at at least one channel location in the flow channel.

25. The valve as recited in claim 24, wherein the constriction of the flow cross-section is realized by at least one nose which (i) extends circumferentially along at least one channel wall and (ii) projects from the at least one channel wall.

26. The valve as recited in claim 25, wherein the at least one nose is produced by a recess impressed in the channel wall.

27. The valve as recited in claim 16, wherein the outer channel wall of the flow channel is formed by a tubular valve housing, and the inner channel wall of the flow channel is formed by a sleeve which is disposed coaxially to the valve housing and accommodates a valve assembly, the valve housing being sealed in fluid-tight manner at a first end face by a connecting piece which includes the intake, and the valve housing being sealed in fluid-tight manner at the second end face by a valve body which includes the metering orifice, and wherein the sleeve (i) extends between the connecting piece and the valve body and (ii) is fixed in place on the connecting piece and the valve body in fluid-tight manner by sleeve ends of the sleeve.

28. The valve as recited in claim 27, wherein a connection from the intake to the flow channel is provided in the connecting piece, and a valve chamber is situated immediately upstream from the metering orifice in the valve body, which is connected to the flow channel via a bore introduced in the valve body.
